(19) United States
(12) Patent Application Publication
(10) Pub. No.: US 2003/0055662 A1
(43) Pub. Date: Mar. 20, 2003

(54) System and method for auditing electronic auctions

(76) Inventor: Kevin Collins, Fort Collins, CO (US)

Correspondence Address: HEWLETT-PACKARD COMPANY, Intellectual Property AdmInistration, P.O. Box 272400, Fort Collins, CO, 80527-2400, US

(21) Appl. No.: 09/955,670

(22) Filed: Sep. 18, 2001

(51) Int. Cl. G06F 17/60

(52) U.S. Cl. 705/1

(57) ABSTRACT

A system for auditing an electronic auction on an auction site includes an auction management module. The auction management module is located on the auction site and manages an auction for a seller. An auction auditing module is in communication with the auction management module, and includes programming to audit an auction taking place on the auction site.

### SPECIFICATION

1. Field of the Invention

The present invention relates generally to electronic auctions and Internet auctions. More particularly, the present invention relates to auditing electronic auctions and Internet auctions.

2. Background

Since the commercialization of the Internet, electronic and online auctions have grown exponentially. There are hundreds, if not thousands, of auctions sites on the web. In the next few years, the online auction industry may even grow to be a billion dollar a year industry. Online auctions attract both goal-directed consumers who are looking for specific products to purchase and entertainment-directed consumers who are looking for entertainment and community through online auctions.

Online auctions are websites that take online shopping to the level of an experience. The bidding experience addresses the need for entertainment, excitement, competition, and winning. There is also a somewhat addictive quality in the nature of auctions that is similar to gambling.

As online auctions become more popular on the Internet, the categories of online auctions have grown and blurred together. Consumers and businesses are more determined to find better deals and online auctions desire more customers. In addition, consumers desire to use an online auction service that is efficient.

One type of online auction is a business-to-business auction. A business-to-business auction allows vendors to sell off excess inventories and dispose of aging surplus merchandise. Consumers see these types of auctions as a good source of bargain items. Another type of auction is the business-to-consumer auction where a business acts as a seller for new items or a reseller of used, reconditioned, and discontinued goods to the end user. The third type of auction is the consumer-to-consumer auction. These are the Internet version of classified ads and try to cash in on the obvious marketing potential of reaching out to a large audience to sell an individual's goods. Furthermore, auction sites offer the promise of sellers receiving more money through competitive bidding and offer extensive exposure.

Electronic auction sites provide several types of auction formats. One popular type of auction is called a Dutch auction. In this format the seller places one or more identical items on sale, at the same time they list a minimum required price to purchase that item. These types of auctions are timed events that usually last a few hours or a few days. When the auction ends, the highest bidders win the items at their bid prices and bids are ranked by price, then quantity and lastly time. Accordingly, only a certain number of bidders can win and this number is equal to the number of items available.

Another type of auction format seen on many sites is called a “reserve price” auction. This format lists a minimum required bid for each seller who lists an item. Buyers are allowed to place bids for any amount above or below the reserve price. However, the seller may use their option to pass over any bids that are under their reserve price. In essence, the seller can decide whether or not to accept a bid that is underneath the seller's reserve bid price.

A final auction type is an express auction, which is a short timed auction lasting between thirty minutes to one hour. These auctions offer bidders an exciting and quick auction experience during a short Internet or online session. Sometimes express auctions occur several times a day or occur at the same time each day. These types of auctions are exciting because the bidders do not need to wait several days to find out whether they have won or not.

There are a number of security and trust issues related to online auctions. Because of the potential problems related to online auctions, the Federal Trade Commission (FTC) has issued certain warnings to buyers and sellers who participate in consumer-to-consumer auctions or even business-to-consumer auctions. Some of these warnings are related to understanding the value of the items that a consumer is bidding for and checking a seller's feedback ratings. The FTC has also issued guidelines to help consumers avoid being defrauded through online auctions, such as using an escrow service, and guidelines to define the courtesies that should be extended between buyers and sellers.

### SUMMARY OF THE INVENTION

The invention provides a system for auditing an electronic auction on an auction site and includes an auction management module. The auction management module is located on the auction site and manages an auction for a seller. An auction auditing module is in communication with the auction management module, to audit an auction taking place on the auction site.

In accordance with a more detailed aspect of the present invention, a system is provided that audits an electronic auction on an auction site. The system comprises an auction management module located on the auction site, and the auction management module hosts an auction for a seller. A plurality of actual bidder inputs, associated with the auction management module, allow actual bidders to place bids in the auction on the auction site. An auction auditing module, in communication with the auction management module, audits an auction taking place on the auction site. Simulated bidder data is also included and controlled by the auction auditing module and can submit at least one bid to auction.

One method for the present invention audits an electronic auction on an auction site that hosts an auction for a seller through an auction management module. The method includes a step of allowing a plurality of actual bidders to place bids in the auction. Another step is generating a simulated bidder through an auction auditing module, wherein the simulated bidder places a bid in the auction. Next, the auction behavior is audited based on the bid placed by the simulated bidder.

Another aspect of the present invention is a method for auditing an electronic auction on an auction site, which hosts auctions for a seller through an auction management module while the auction is online. The method includes the step of interrupting online operations of the auction and auction management module. Another step is inhibiting any modifications to the auction and auction management module. Next, a simulated auction is executed using simulated bidders and a simulated seller. An additional step is testing the auction and auction management module based on the simulated auction. A cleanup step is returning the auction and auction management module to online operation.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of a system for auditing electronic auctions.

FIG. 2 is a block diagram illustrating a system for auditing auction software where the entire auction is simulated.

### DETAILED DESCRIPTION

For purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

With the increasing widespread use of electronic auctions for business and personal purchases, it has become important to have those auctions audited and managed to certify that the auction is conducted in a fair manner. Goods are being sold through normal auction or reverse-auction type of arrangements, and both of these types of auctions can be verified and audited through the present invention.

Businesses are especially sensitive to the fairness of auctions because they are likely to purchase more goods through this channel as the Internet becomes more mature. Customers in business-to-customer auctions are also sensitive to this issue because they tend to assume that auction web sites are honest and believe that there is a level of security and reliability for the auction.

In addition to the trust issues that exist between the buyers and sellers, there are also issues related to the auction software used by the website. Users should be able to determine that the auction software used by the auction site is effective, honest, and verifiable. It is important for a user to know that the software employed by the auction site is not fraudulent or partial to bidders who try to manipulate or hack into the auction engine. Unfortunately in the past, it has not been possible for consumers to determine whether an auction site is using secure or trustworthy auction methods and software. Auditing an electronic auction helps overcome these problems.

Although, auditing is not unknown in the business world, it usually takes place within a number of specific situations. Financial audits are performed by accountants for entities that desire to verify that their accounting procedures and financial figures are correct. Security audits and quality assurance audits may also take place within companies, but these are generally focused on informing a company whether their internal security and quality processes are effective. For example, banks are self-auditing because their customers track their financial balances independently and banks also employ external financial auditors.

In a similar manner, software is tested before it is released into the marketplace. This type of software verification typically focuses on testing the reliability, speed and predefined functionality of the software as determined by the software or hardware developer. Further, computer software and hardware is sometimes tested internally to verify that the systems are operating properly. These types of tests are not directed toward certifying any specific functionality for the end users, but are directed toward internal verifications.

In contrast, users who utilize electronic auctions have no guarantee that the auction management software operates as they expect it should operate, and there is also no assurance that the electronic auction is fair. The general definition of a fair auction can include the fact that the correct winner is selected based on the highest bidder. Another criterion can be that bids are displayed in a timely manner after they are submitted and cannot be blocked or delayed by another bidder. Yet another criterion is whether the seller data and buyer data submitted to the auction are accurate and the auction display reflects what was actually submitted.

Electronic auction users assume that auctions adhere to these types of rules but there is no guarantee that this is the case. Unscrupulous auction web sites may modify the operation of their auctions or web site to take advantage of unsuspecting consumers or users. Hackers may also exploit weaknesses in the electronic bidding systems.

One problem with auctions is that it can be very difficult for users to personally audit the auction process because of the number of variables involved. An auction includes a seller, a number of bidders and the auction software itself. These elements are also presented in a real-time environment to the user and the average auction user cannot easily verify these variables for their correctness. Moreover, users have not generally recognized the need to verify that an auction is honest or fair because the possible problems that can arise in an auction are not widely known. The public, auction web sites, and corporations have assumed that electronic auctions are inherently fair.

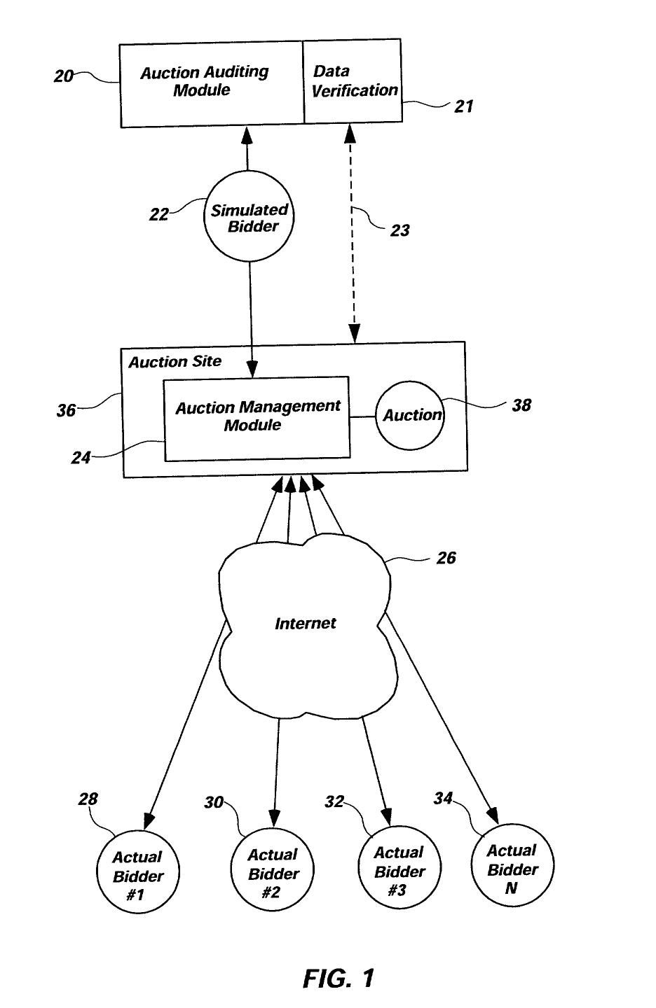

FIG. 1 illustrates an auction auditing module 20 that audits an auction management module 24. An auction site 36 provides an auction 38 and desires to be “certified” for authenticity and fairness purposes. The auction site can be a web site, wireless phone interface, or some other electronic interface that provides a connection to an electronic auction. The auction auditing module and/or auditing server is in electronic communication with the auction management module 24.

In one embodiment, the auction auditing module 20 can be integrated into a third party's auction management suite. This means the auction auditing module may reside on the same server as the auction management module 24. In another embodiment, the auction auditing module accesses the auction management module over a network. A relatively high level of integration into the target auction management module or direct communication between the auction auditing module and the auction management module can expedite the auditing. Additionally, it can be valuable for the auction auditing module to have direct access to databases and other processes that take place in the auction management module.

When an auction starts, a simulated bidder 22 and/or simulated bidder data is provided by the auction auditing module 20 to participate in the auction and make one or more bids. This is important because it allows the auction auditing module to verify that the simulated bidding data is represented in the auction management module in exactly the same way it was sent from the simulated bidder.

As an auction proceeds and finally closes, the auction auditing module 24 that is interfaced with the auction site 36 is used to determine whether or not the simulated bidder's 22 controlled bid was represented fairly and accurately. The auction auditing module then validates that the auction management module automatically selected the best bid. In the event that the auction auditing module's agent won the auction, that bid is removed in the background and the next best bidder is selected and reported to the sellers. This allows the live auditing of an auction to take place without the knowledge of the sellers. The auction management module can have a plurality of actual bidder inputs to receive the data from the actual bidders. Use of the auction auditing module 20 is valuable because the auction auditing module can see the data that is presented to the actual bidders 28, 30, 32, 34 and it can also see the data that is being submitted to the auction management module by the simulated bidder. The auction auditing module can then compare those two sets of data to make sure that they are consistent.

There are a number additional details relating to ways that items can be checked using a simulated bidder. If the simulated bidder 22 has the highest bid and it is not selected, this can represent an error in the auction management module. This is best tested in an environment where the seller is the auction site owner. Accordingly, if the simulated bidder wins then the auction item can be easily re-auctioned. If the auction item is owned by an individual, who will not want to re-auction the item, one low bid can be submitted for testing purposes. Alternately, the users can be informed that some auditing may be conducted by the auction site owner and that their auction may need to be re-auctioned or where the seller is a company or the web site no liability will be incurred.

Another item in the auction management module that can be effectively tested is the auction item descriptions and details that are displayed to the bidder. The auction auditing module can capture the actual display screen data that is presented for item descriptions and then compare that display screen data to the actual database information that is stored by the auction site 36 or auction management module 24. Its item description data can also be compared to the item data submitted by the seller. A data verification module 21 can be used to request data 23 from the auction management module, database and from the auction itself. Among other things, the data verification module compares the data sent by the auction auditing module to determine if the data is displayed correctly in the auction processes and databases. In business-to-business auctions, the audit can also test a wide range of attributes including price, quality, and other factors that can vary by industry.

This auditing process is generally more effective with the full support and compliance of the auction site and/or the auction site software vendor. In order to receive an auction certification, the auction site will desire to have the auditing software applied to their web site because it can allows them to represent that their auction software has been tested and approved by a third party certification group.

It should be mentioned that one communication difference between the simulated bidder 22 and the actual bidders is that the actual bidders 28, 30, 32, 34 will communicate with the auction management module through an Internet web connection 26 or a similar networking connection. On the other hand, a simulated bidder can reside either on the same server with the auction site or a server that is in high-speed communication with the auction site 36. Of course, the auction auditing module may be located remotely from the auction site and communicate through a separate communications interface such as a wireless or dial-up connection.

Regardless of the communication method used for auditing, the simulated bidder can be set up with different rights or privileges for accessing data within the auction site. One level of rights is similar to actual bidder rights, where the auction auditing module verifies the auction's display interface using information sent through normal bidding channels. This could be considered similar to a black box audit. Another level of rights is where the simulated bidder and auction auditing software access the database and other system processes in the auction site to verify they are processing the auction information properly. In other words, a white box type of audit. All of the audit information will preferably be processed automatically but can also be output to a log or a graphic interface component for further viewing by a human analyst as needed.

Some auction sites provide a guarantee with respect to protecting a user or buyer's personal information. They provide these guarantees through a third-party group such as TRUSTe. The online auction sites belong to these third party privacy groups, which certify the websites and auction sites adhere to a certain level of privacy. This certification generally verifies that the auction sites will protect a user's identity by avoiding conduct that would breach privacy standards. For example, the auction site agrees not sell the user's private information or use the personal information for marketing purposes, etc. In contrast to this type of privacy auditing, the present invention audits an auction web site while it is actually online and capable of performing live auctions. Applying online automated audit tools to test auction systems and methods provides an extra level of protection that auction users have not had before.

The present invention can also aid in detecting whether or not certain sellers are using a shill to inflate the price of items that they are auctioning. This can be done in at least two ways. The first method for detecting a shill is by using a shill detection module located in the auction audit module to audit selected auctions after they are complete. This determines if the price paid for the auction item by the actual winner is within a predetermined price tolerance of other similar items with quantitatively the same characteristics. For example, a seller in a consumer-to-consumer auction may auction off a video camera. A number of other video cameras with the same make and model are likely to have been sold within the same month on the auction site. Accordingly, the auction auditing module can compare the current auction selling price to see if it is within a pre-determined percentage of the mean price of the other auctions performed for the same item. So, if the price of the item exceeds a predetermined percentage (e.g., 40-75%) of the other auction prices paid, then this auction can be flagged for more detailed review by a human analyst. This way the auction site can create a log of sellers who may be unfairly influencing the price of their auction items.

In addition, if a specific seller who uses the auction site is suspected of using or being a shill because of the history, then the system can supply one or more simulated bidders to aid in determining if a shill exists. In this situation, the simulated bidders can be programmed to have certain behaviors. One method is to provide a simulated bidder who will bid an unlimited amount of money against a suspected shill. When the bidding exceeds a pre-selected percentage of a mean price for similar goods (e.g., 50% greater than the mean price for the exact item), and no other actual bidders are bidding, then the suspected shill and the simulated bidder can be separated into a “private bid room”. This means that the other bidders who have stopped bidding at this point will not be able to see any further bids. The simulated bidder is then allowed to bid as high as the suspected shill is willing to bid. At this point, the shill is informed that they are winner of the auction. They may also be informed that they are being audited or simply that the simulated bidder has been disqualified. The other bidders are also notified that the suspected shill has won the bidding. This auditing system can discourage shill bidders and be used when a seller is suspected of using a shill. The seller who is using a shill can then be investigated and removed from the system if necessary.

A separate method is to use two or more simulated bidders who will bid against the shill. The two or more simulated bidders would not bid against each other because the auction auditing module controls them and they only bid against the shill. This way the shill would be less likely to see some sort of audit. When the auction concludes, the winning simulated agent is “disqualified” and the suspected shill is informed that they have won. The suspected shill can also be notified that they are suspected of being a shill. If a pattern of shill behavior is verified by a human analyst using the simulated bidders, then the specific user or company can be removed from the system. This method of detecting shills operates best when the goods being sold are uniform and identifiable.

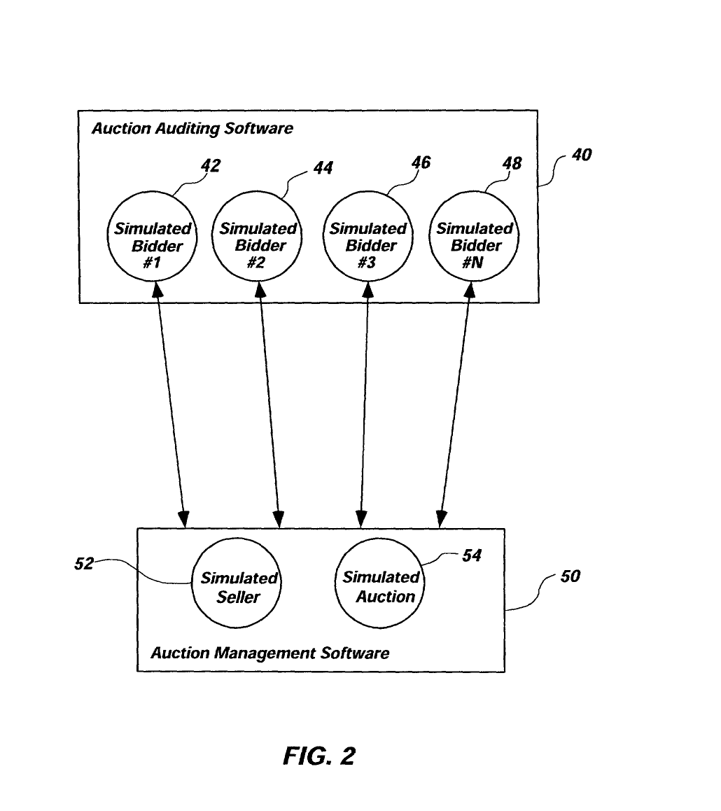

FIG. 2 illustrates an embodiment of the invention that tests the operation of the auction management module and auction without any real bidder or real seller interaction. This fully simulated auction takes place after the auction management software has been installed and is running on the auction site for a period of time. This provides an audit that is significantly different than development testing. The fairness of the auction site is tested once the auction is loaded and running because then an actual test of the live auction processes can be made.

In this configuration, a simulated seller 52 is created in the auction management software 50 as directed by the auction auditing software 40. Two or more simulated bidders are created within the auction auditing software to simulate all the bidders 42, 44, 46, 48 for the entire simulated auction 54. The system tests the same processes and data that were described before for the live auction embodiment. This embodiment also takes advantage of the same software integration configurations that were described previously.

To provide an impartial and untainted audit, a fully simulated audit is most effectively performed as an unannounced check of the auction system. In this mode, the auction auditing software 40 contacts the auction management software 50 and informs it to suspend any further auction activity. Preferably this mode is executed in such a manner as to allow the auction web site to continue operation while this is being executed invisibly to any potential end users. Alternately, at this point, the auction auditing software would restrict or inhibit any outside access to the auction management software and its related database and software so as to ensure that no modifications are made to the system before or during testing.

A simulated auction is then initiated and the system audits the auction. The audit can include testing the information submitted by the bidder and seller, the accuracy of displayed data, and the responsiveness of the auction system. Again, the auction auditing software can test to see if the correct winner was selected. The bids that were submitted can also be tested to see if the bids were represented exactly as they were submitted. Another important aspect that can be tested in a fully simulated auction is the latency involved in posting the submissions from the bidders or seller. In fact, a simulated bidder can also be located on a networked computer at a separate location from the auction auditing software. This aids in the latency testing of the auction management software and the ability of bidders to connect to the auction properly. After the audit, normal auction activity can resume. A reverse auction can also be tested in the same way as a regular auction with the exception that there are many suppliers and only one purchaser.

A fully simulated audit allows an auditing body to confirm that the processes in the auction are accurate and fair. It also can determine that the auction software is not being manipulated by outside influences such as hackers, corrupt site administrators, software defects or other similar problems.

It is to be understood that the above-described arrangements are only illustrative of the application for the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A system for auditing an electronically based auction, which is located on an auction site, comprising:
(a) an auction management module, located on the auction site, wherein the auction management module manages the auction for a seller; and
(b) an auction auditing module, in communication with the auction management module, to audit the auction taking place on the auction site.

2. A system as in claim 1, wherein the auction auditing module audits the auction to verify that the auction functions in a manner consistent with represented procedures of the auction site.

3. A system as in claim 1, further comprising a data verification component to verify that data submitted to the auction is represented accurately in the auction.

4. A system as in claim 1, further comprising a data verification component to verify that a correct winning bidder was selected.

5. A system as in claim 4, further comprising simulated bidder data, wherein the simulated bidder data is removed in the background from the auction management module in the event that the simulated bidder data wins the auction and a next best bidder is selected and reported to a seller.

6. A system as in claim 1, further comprising a plurality of actual bidder inputs, which enable submission of bids to the auction through the auction management module.

7. A system as in claim 1, further comprising an audit server to host the auction auditing module, wherein the auction auditing module is in networked communication with the auction management module.

8. A system as in claim 1, further comprising an auction server that hosts the auction management module.

9. A system as in claim 8, wherein the auction auditing module is hosted on an auction server with the auction management module.

10. A system for auditing an electronically based auction, which is located on an auction site, comprising:
(a) an auction management module, located on the auction site, wherein the auction management module hosts the auction for a seller;
(b) a plurality of actual bidder inputs, associated with the auction management module, to allow actual bidders to place bids in the auction on the auction site;
(c) an auction auditing module, in communication with the auction management module, to audit an auction taking place on the auction site; and
(d) simulated bidder data, controlled by the auction auditing module, to submit at least one bid to the auction.

11. A system as in claim 10, further comprising a data verification component to verify that data submitted to the auction with the simulated bidder data is represented accurately and that a correct winning bidder is selected.

12. A system as in claim 10 further comprising a shill detection module located in the auction audit module that detects the possibility that a seller is using a shill who is making bids in the auction.

13. A system as in 10, wherein the simulated bidder data includes at least one bid to verify that bids are represented accurately in the auction management module.

14. A method for auditing an electronically based auction, which is located on an auction site that manages an auction for a seller through an auction management module, comprising the steps of:
(a) allowing a plurality of actual bidders to place bids in the auction;
(b) generating a simulated bidder through an auction auditing module;
(c) receiving a bid from the simulated bidder in the auction; and
(d) auditing the auction's behavior based on the bid placed by the simulated bidder.

15. A method as in claim 14, wherein the step of auditing the auction's behavior further comprises the step of determining if the auction is fair by verifying that the simulated bidder's bid is represented accurately by the auction management module.

16. A method as in claim 14, wherein the step of auditing the auction's behavior further comprises the step of validating that a best bid was programmatically selected by the auction management module as a winner of the auction.

17. A method as in claim 14, wherein the step of auditing the auction behavior further comprises the step of verifying the accuracy of all competing bids to determine whether or not a correct auction winner was selected.

18. A method for auditing an electronically based auction, which is located on an auction site that manages an auction for a seller through an auction management module, wherein the audit is performed when the auction is active, comprising the steps of:
(a) interrupting online operations of the auction and auction management module;
(b) inhibiting any modifications to the auction and auction management module;
(c) executing a simulated auction using simulated bidders and a simulated seller;
(d) auditing the auction and auction management module based on the simulated auction;
(e) returning the auction and auction management module to online operations.

19. A method as in claim 18, wherein the step of auditing the auction and auction management module further comprises the step of verifying that a correct auction winner was selected based on simulated bids made by the simulated bidders.

20. A method as in claim 18, wherein the step of auditing the auction and auction management module further comprises the step of verifying output from the auction management module based on simulated bids made by the simulated bidders.

21. A method as in claim 18, wherein the step of auditing the auction and auction management module further comprises the step of verifying displayed description output from the auction management module for an auction item submitted by the simulated seller.
